(19) United States
(12) Patent Application Publication
(10) Pub. No.: US 2023/0352782 A1
(43) Pub. Date: Nov. 2, 2023

(54) BATTERY

(71) Applicant: MURATA MANUFACTURING CO., LTD., Kyoto (JP)

(72) Inventors: Moriaki OKUNO, Kyoto (JP); Yoshiichi HORIKOSHI, Kyoto (JP); Taichi KATSUMOTO, Kyoto (JP)

(21) Appl. No.: 18/218,458

(22) Filed: Jul. 5, 2023

Related U.S. Application Data
(63) Continuation of application No. PCT/JP2021/044938, filed on Dec. 7, 2021.

(30) Foreign Application Priority Data
Jan. 6, 2021 (JP) 2021-001085

(51) Int. Cl. H01M 50/188; H01M 50/152; H01M 50/107; H01M 10/04; H01M 10/0587; H01M 50/538; H01M 10/0525

(52) U.S. Cl. CPC H01M 50/188; H01M 10/0431; H01M 10/0525; H01M 10/0587; H01M 50/107; H01M 50/152; H01M 50/538

(57) ABSTRACT

A battery includes an outer package member, a battery device, a sealing member, and a terminal member. The outer package member has an outer diameter and a height. The battery device is contained inside the outer package member. The sealing member has an insulating property. The terminal member is supported by the outer package member via the sealing member. A ratio of the outer diameter to the height is greater than or equal to 0.1 and less than 1. The outer package member includes a container member and a cover member. The container member has an opening, and contains the battery device in an inside of the container member. The cover member is welded to the container member, closes the opening, and has a through hole. The terminal member is fixed to the cover member via the sealing member, and covers the through hole. A fixation strength of the terminal member to the cover member is lower than a welding strength of the cover member to the container member.

### CROSS REFERENCE TO RELATED APPLICATIONS

The present application is a continuation of PCT patent application no. PCT/JP2021/044938, filed on Dec. 7, 2021, which claims priority to Japanese patent application no. 2021-001085, filed on Jan. 6, 2021, the entire contents of which are incorporated herein by reference.

### BACKGROUND

The present technology relates to a battery.

A battery has been developed as a power source for using electronic equipment. Such a battery includes a battery device inside an outer package can. A configuration of the battery has been considered in various ways in order to improve various characteristics.

Specifically, in order to increase a volume energy density, a weld-sealed outer package casing is used in which a cover plate member is welded to a casing body, and the casing body has a bottom surface to which a flat-plate-shaped electrode terminal member is fixed via a seal member.

### SUMMARY

The present technology relates to a battery.

Although consideration has been given in various ways regarding a configuration of a battery, a battery capacity characteristic and safety of the battery are not sufficient yet. Accordingly, there is room for improvement in terms thereof.

It is therefore desirable to provide a battery that makes it possible to achieve a superior battery capacity characteristic and superior safety.

A battery according to an embodiment of the present technology includes an outer package member, a battery device, a sealing member, and a terminal member. The outer package member has an outer diameter and a height. The battery device is contained inside the outer package member. The sealing member has an insulating property. The terminal member is supported by the outer package member via the sealing member. A ratio of the outer diameter to the height is greater than or equal to 0.1 and less than 1. The outer package member includes a container member and a cover member. The container member has an opening, and contains the battery device in an inside of the container member. The cover member is welded to the container member, closes the opening, and has a through hole. The terminal member is fixed to the cover member via the sealing member, and covers the through hole. A fixation strength of the terminal member to the cover member is lower than a welding strength of the cover member to the container member.

According to the battery of an embodiment of the present technology: the battery device is contained inside the outer package member whose ratio of the outer diameter to the height is greater than or equal to 0.1 and less than 1; in the outer package member, the cover member having the through hole is welded to the container member; the terminal member is fixed to the cover member via the sealing member having the insulating property; and the fixation strength of the terminal member to the cover member is lower than the welding strength of the cover member to the container member. Accordingly, it is possible to achieve a superior battery capacity characteristic and superior safety.

Note that effects of the present technology are not necessarily limited to those described above and may include any of a series of effects described below in relation to the present technology.

### BRIEF DESCRIPTION OF THE FIGURES

FIG. 1 is a sectional view of a configuration of a secondary battery that is an example of a battery according to an embodiment of the present technology.

FIG. 2 is a sectional view of a configuration of a battery device illustrated in FIG. 1.

FIG. 3 is a sectional view for describing an operation of the secondary battery.

FIG. 4 is a sectional view for describing a process of manufacturing the secondary battery.

FIG. 5 is a sectional view of a configuration of a secondary battery according to a first comparative example.

FIG. 6 is a sectional view of a configuration of a secondary battery according to a second comparative example.

FIG. 7 is a sectional view of a configuration of a secondary battery according to an embodiment.

FIG. 8 is a sectional view of a configuration of a secondary battery according to an embodiment.

### DETAILED DESCRIPTION

One or more embodiments of the present technology are described below in further detail including with reference to the drawings.

A description is given first of a battery according to an embodiment of the present technology.

The battery to be described here is an electrochemical unit that generates a battery capacity using an electrode reaction, and is used as a power source for using electronic equipment. The battery may be a primary battery or a secondary battery. Further, a discharge principle of the primary battery is not particularly limited, and a charge and discharge principle of the secondary battery is not particularly limited.

In the following, a description is given of the secondary battery as an example of the battery. The secondary battery obtains a battery capacity using, as the electrode reaction, insertion and extraction of an electrode reactant (charging and discharging reactions). The secondary battery includes a positive electrode, a negative electrode, and an electrolytic solution that is a liquid electrolyte.

Note that, in the secondary battery to be described below, a charge capacity of the negative electrode is greater than a discharge capacity of the positive electrode. In other words, an electrochemical capacity per unit area of the negative electrode is set to be greater than an electrochemical capacity per unit area of the positive electrode. This is to prevent precipitation of the electrode reactant on a surface of the negative electrode during charging.

The electrode reactant is not particularly limited in kind, and specific examples thereof include a light metal such as an alkali metal or an alkaline earth metal. Examples of the alkali metal include lithium, sodium, and potassium. Examples of the alkaline earth metal include beryllium, magnesium, and calcium.

Here, examples are given of a case where the electrode reactant is lithium. A secondary battery that obtains a battery capacity using insertion and extraction of lithium is what is called a lithium-ion secondary battery. In the lithium-ion secondary battery, lithium is inserted and extracted in an ionic state.

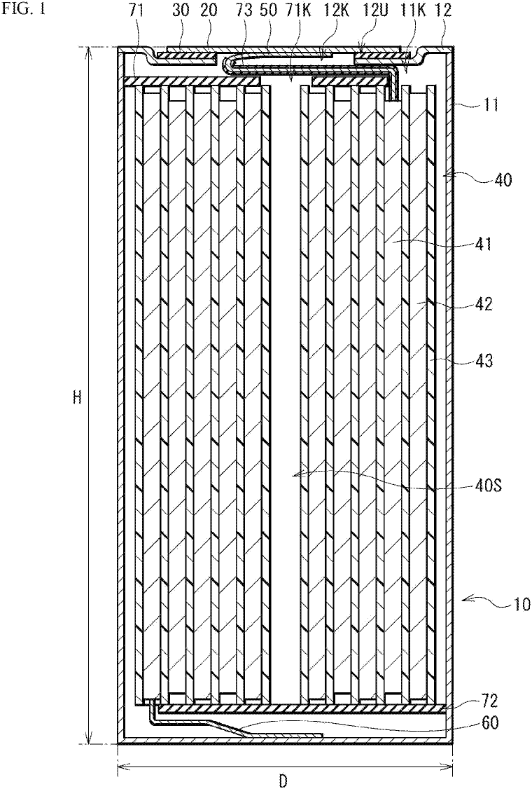

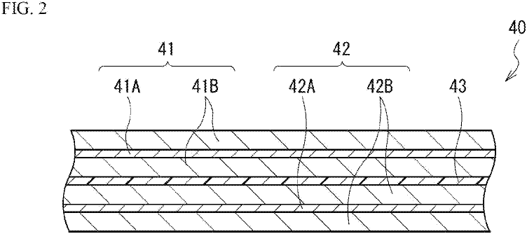

FIG. 1 illustrates a sectional configuration of the secondary battery that is an example of the battery. FIG. 2 illustrates a sectional configuration of a battery device 40 illustrated in FIG. 1. FIG. 2 illustrates only a portion of the battery device 40.

Hereinafter, for convenience, an upper side in FIG. 1 will be described as an upper side of the secondary battery, and a lower side in FIG. 1 will be described as a lower side of the secondary battery.

As illustrated in FIG. 1, the secondary battery has a cylindrical three-dimensional shape having an outer diameter D and a height H. The outer diameter D is a dimension in a lateral direction in FIG. 1, and is what is called a maximum outer diameter. The height H is a dimension in a vertical direction in FIG. 1, and is what is called a maximum height.

Here, the secondary battery has two circular base parts opposed to each other, and thus has the cylindrical three-dimensional shape. In other words, the secondary battery illustrated in FIG. 1 is what is called a secondary battery of a cylindrical type.

The secondary battery has the cylindrical three-dimensional shape as described above, and thus has a ratio of the outer diameter D to the height H, i.e., an aspect ratio defined by outer diameter D/height H, of greater than or equal to 0.1 and less than 1. A reason for this is that, as compared with a case where the aspect ratio is 1, an internal capacity of the secondary battery available for containing the battery device 40 increases, which allows for a higher volume energy density. Another reason is that, as compared with a case where the aspect ratio is less than 0.1, it becomes easier for an electrode terminal 20 to serve as a release valve, as will be described later.

The aspect ratio is not particularly limited as long as the aspect ratio is greater than or equal to 0.1 and less than 1. In particular, the aspect ratio is preferably greater than or equal to 0.1 and less than or equal to 0.6, and more preferably greater than or equal to 0.1 and less than 0.5. A reason for this is that the internal capacity of the secondary battery further increases, which further increases the volume energy density.

Specifically, the secondary battery includes, as illustrated in FIGS. 1 and 2, an outer package can 10, the electrode terminal 20, a gasket 30, the battery device 40, a positive electrode lead 50, a negative electrode lead 60, a pair of insulating plates 71 and 72, and a sealant 73.

As illustrated in FIG. 1, the outer package can 10 is an outer package member that contains the battery device 40 and other components, and has a cylindrical three-dimensional shape having the outer diameter D and the height H. In other words, the three-dimensional shape of the secondary battery is substantially determined based on the three-dimensional shape of the outer package can 10. Details of the aspect ratio defined by the outer diameter D and the height H are as described above.

The outer package can 10 includes a container part 11 and a cover part 12 that are welded to each other, and the container part 11 is sealed by the cover part 12.

The container part 11 is a container member that contains the battery device 40 and other components in an inside thereof, and has a hollow cylindrical three-dimensional shape with one end part open and another end part closed. Thus, the container part 11 has an opening 11K that is the opened one end part.

The cover part 12 is a cover member that closes the opening 11K, and has a three-dimensional shape that is substantially a plate shape. The cover part 12 has a through hole 12K to allow the electrode terminal 20 and the battery device 40 to be coupled to each other, and is welded to the container part 11 to close the opening 11K as described above. As will be described later, the cover part 12 supports the electrode terminal 20 via the gasket 30.

The through hole 12K has an inner diameter (a maximum inner diameter) that is not particularly limited, and is preferably larger than an inner diameter (a maximum inner diameter) of a winding center space 40S to be described later, in particular. A reason for this is that an exposed area of the electrode terminal 20 in the through hole 12K increases. As a result, upon an excessive rise in an internal pressure of the outer package can 10, the electrode terminal 20 is easily pushed toward an outer side at the through hole 12K by the internal pressure. This makes it easier for the electrode terminal 20 to operate as the release valve, as will be described later. Further, a coupling area of the positive electrode lead 50 to the electrode terminal 20 increases, and this makes it easier to secure a state in which the electrode terminal 20 and the positive electrode lead 50 are electrically coupled to each other.

For example, the inner diameter of the through hole 12K is preferably larger than or equal to 1 mm. A reason for this is that the above-described advantages are obtainable and the positive electrode lead 50 is easily coupled to the electrode terminal 20 by a method such as a welding method.

Here, the cover part 12 bends to protrude in part toward the inside, i.e., in a downward direction, of the container part 11, thus being recessed in part. In other words, a portion of the cover part 12 bends to form a level difference toward a center of the cover part 12. The cover part 12 thus has a recessed part 12U. The cover part 12 has the above-described through hole 12K inside the recessed part 12U.

Here, the outer package can 10 is a can in which two members, i.e., the container part 11 and the cover part 12, are welded to each other, and is what is called a welded can. As a result, the outer package can 10 once welded is physically a single member as a whole, and is thus in a state of not being easily separable into the two members, i.e., the container part 11 and the cover part 12, afterward.

The outer package can 10 as a welded can does not include any portion folded over another portion, and does not include any portion in which two or more members lie over each other.

The wording “does not include any portion folded over another portion” means that the outer package can 10 is not processed in such a manner as to include a portion folded over another portion, that is, the outer package can 10 has not been subjected to a bending process. The wording “does not include any portion in which two or more members lie over each other” means that the outer package can 10 after completion of the secondary battery is physically a single member and is thus not easily separable into two or more members. In other words, the outer package can 10 in the completed secondary battery is not in a state in which two or more members lie over each other and are combined in such a manner as to be easily separable into the two or more members afterward.

The outer package can 10 as a welded can is what is called a crimpless can, being different from a crimped can formed by means of a crimping process. A reason for employing the crimpless can is that this increases a device space volume inside the outer package can 10, and accordingly increases an energy density per volume. The “device space volume” refers to a volume (an effective volume) of an internal space of the outer package can 10 available for containing the battery device 40 therein.

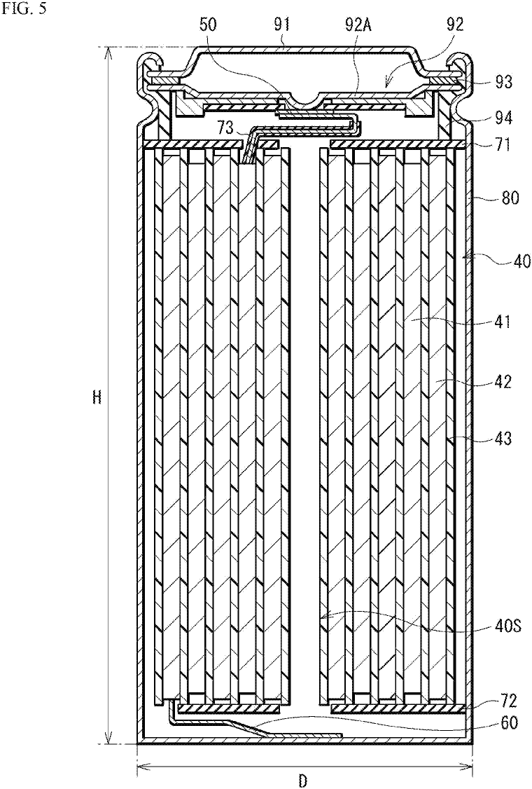

Another reason for employing the welded can (the crimpless can) as the outer package can 10 is that this makes a series of components (special mechanisms and devices) including, for example, a safety valve mechanism 92 and a PTC device 93 unnecessary as compared with a case where a crimped can is employed as an outer package can 80 to be described later (see FIG. 5). As a result, provided that the height H of the secondary battery is kept constant, the device space volume increases by a volume to be occupied by the unnecessary special mechanisms and devices described above, and accordingly, the energy density per volume increases.

The outer package can 10 including the container part 11 and the cover part 12 is electrically conductive. Here, the container part 11 of the outer package can 10 is coupled to a negative electrode 42, which will be described later, of the battery device 40, via the negative electrode lead 60. Accordingly, the outer package can 10 is electrically coupled to the negative electrode 42, and thus serves as an external coupling terminal of the negative electrode 42. A reason for employing such a configuration is that this makes it unnecessary to provide the external coupling terminal of the negative electrode 42 separate from the outer package can 10, thus suppressing a reduction in the device space volume due to the presence of the external coupling terminal of the negative electrode 42. This results in an increase in device space volume, and accordingly an increase in energy density per unit volume.

Specifically, the outer package can 10 includes one or more of electrically conductive materials including, without limitation, a metal material and an alloy material. Examples of the electrically conductive material include iron, stainless steel (SUS), aluminum, and an aluminum alloy. A surface of the outer package can 10 may be plated with a metal material such as nickel. Note that the container part 11 and the cover part 12 may include the same material, or may include respective materials different from each other.

Note that the cover part 12 is insulated, via the gasket 30, from the electrode terminal 20 serving as an external coupling terminal of a positive electrode 41, which will be described later, of the battery device 40. A reason for this is that contact or a short circuit between the outer package can 10 (the external coupling terminal of the negative electrode 42) and the electrode terminal 20 (the external coupling terminal of the positive electrode 41) is thereby prevented.

The electrode terminal 20 is a plate-shaped terminal member to be coupled to electronic equipment when the secondary battery is mounted on electronic equipment, and is supported by the outer package can 10 (the cover part 12) via the gasket 30, as illustrated in FIG. 1. In other words, the electrode terminal 20 is supported by the cover part 12 while being insulated from the cover part 12 via the gasket 30.

Thus, the electrode terminal 20 is fixed to the cover part 12 via the gasket 30. Further, the electrode terminal 20 covers the through hole 12K, and a portion of the electrode terminal 20 is thus exposed in the through hole 12K.

Here, the electrode terminal 20 is coupled to the positive electrode 41 via the positive electrode lead 50, as described above. Thus, the electrode terminal 20 is electrically coupled to the positive electrode 41, and thus serves as the external coupling terminal of the positive electrode 41. Accordingly, upon use of the secondary battery, the secondary battery is coupled to the electronic equipment via the electrode terminal 20 (the external coupling terminal of the positive electrode 41) and the outer package can 10 (the external coupling terminal of the negative electrode 42). This makes it possible for the electronic equipment to operate with use of the secondary battery as a power source.

In addition, upon the excessive rise in the internal pressure of the outer package can 10, the electrode terminal 20 serves as the release valve that releases the internal pressure. Factors that contribute to the rise in the internal pressure described above include gas generation due to a decomposition reaction of the electrolytic solution upon charging and discharging. Factors that speed up the decomposition reaction of the electrolytic solution include an internal short circuit of the secondary battery and a discharge of the secondary battery by heating of the secondary battery or under a large-current condition.

Specifically, in normal times, the electrode terminal 20 is fixed to the cover part 12 via the gasket 30, and the through hole 12K is thus covered by the electrode terminal 20. As a result, the outer package can 10 is sealed, and the battery device 40 is thus sealed in the outer package can 10.

In contrast, upon the occurrence of an abnormal condition, that is, upon the excessive rise in the internal pressure of the outer package can 10, an exposed surface of the electrode terminal 20 at in the through hole 12K is strongly pushed toward the outer side (the upper side) by the internal pressure. In this case, if the internal pressure exceeds a fixation strength (what is called a seal strength) of the electrode terminal 20 to the cover part 12, the electrode terminal 20 is separated in part or in entirety from the cover part 12. As a result, a gap, that is, a release path of the internal pressure, develops between the cover part 12 and the electrode terminal 20, and the internal pressure is thus released through the use of the gap.

The electrode terminal 20 is disposed inside the recessed part 12U via the gasket 30, and is thus insulated from the cover part 12 via the gasket 30 as described above. Here, the electrode terminal 20 is contained inside the recessed part 12U in such a manner as not to protrude upward from the cover part 12. A reason for this is that this decreases the height H of the secondary battery as compared with a case where the electrode terminal 20 protrudes upward from the cover part 12, and accordingly increases the energy density per volume.

Further, the electrode terminal 20 is disposed on an outer side of the cover part 12, and is thus disposed inside the recessed part 12U as described above. A reason for this is that, upon the excessive rise in the internal pressure of the outer package can 10, the electrode terminal 20 is more easily separated from the cover part 12 by the internal pressure as compared with a case where the electrode terminal 20 is disposed on an inner side of the cover part 12, which makes it easier to release the internal pressure.

Note that the electrode terminal 20 has an outer diameter smaller than an inner diameter of the recessed part 12U, and is therefore separated from the cover part 12 therearound. Accordingly, the gasket 30 is provided inside the recessed part 12U and in a gap between the electrode terminal 20 and the cover part 12, more specifically, only at a location in which the electrode terminal 20 and the cover part 12 could contact each other if not for the gasket 30.

Further, the electrode terminal 20 includes one or more of electrically conductive materials including, without limitation, a metal material and an alloy material. Examples of the electrically conductive material include aluminum and an aluminum alloy. Note that the electrode terminal 20 may include a cladding material. The cladding material includes an aluminum layer and a nickel layer in this order from a side closer to the gasket 30. In the cladding material, the aluminum layer and the nickel layer are roll-bonded to each other.

Here, as described above, the cover part 12 is welded to the container part 11, whereas the electrode terminal 20 is fixed to the cover part 12 via the gasket 30. In this case, the fixation strength of the electrode terminal 20 to the cover part 12 is lower than the welding strength of the cover part 12 to the container part 11. In other words, an unsealing pressure (kgf/cm²) of the electrode terminal 20, i.e., a pressure at which the electrode terminal 20 is separated from the cover part 12, is lower than an unsealing pressure (kgf/cm²) of the outer package can 10, i.e., a pressure at which the cover part 12 is separated from the container part 11.

A reason for this is that this causes, upon the excessive rise in the internal pressure of the outer package can 10, the electrode terminal 20 to be easily separated from the cover part 12 prior to separation of the cover part 12 from the container part 11. This makes it easier for the electrode terminal 20 to operate as the release valve prior to a rupture of the secondary battery (the outer package can 10), thereby preventing the battery device 40 having a high temperature from being unintentionally ejected from an inside to an outside of the outer package can 10.

In this case, when the aspect ratio is greater than or equal to 0.1 in particular, the exposed surface of the electrode terminal 20 is sufficiently easily pushed toward the outer side upon the rise in the internal pressure, unlike a case where the aspect ratio is less than 0.1. This makes it easier for the electrode terminal 20 to serve stably as the release valve.

The fixation strength of the electrode terminal 20 to the cover part 12 is adjustable based on conditions including, without limitation, a material included in the gasket 30 and a fixation area of the electrode terminal 20 with respect to the cover part 12. The welding strength of the cover part 12 to the container part 11 is adjustable based on conditions including, without limitation, a welding method, a welding time, and a welding area.

The fixation strength is identifiable by applying pressure to the inside of the secondary battery while measuring the internal pressure of the outer package can 10 in an ambient temperature environment (at a temperature of 23° C.). In this case, the internal pressure at a time when the electrode terminal 20 is separated from the cover part 12, that is, the pressure at which the outer package can 10 is unsealed with use of the electrode terminal 20, i.e., the unsealing pressure, is identified, thereby determining the unsealing pressure as the fixation strength.

The welding strength is identifiable by a procedure similar to that of identifying the fixation strength described above. In other words, pressure is applied to the inside of the secondary battery while measuring the internal pressure of the outer package can 10 in the ambient temperature environment, following which the internal pressure at a time when the cover part 12 is separated from the container part 11, that is, the pressure at which the outer package can 10 is unsealed with use of the cover part 12, i.e., the unsealing pressure, is identified, thereby determining the unsealing pressure as the welding strength.

A ratio of the outer diameter of the electrode terminal 20 to the inner diameter of the through hole 12K, that is, a fixation ratio that determines the fixation area of the electrode terminal 20 with respect to the cover part 12, is not particularly limited, and is preferably within a range from 1.13 to 3.37 both inclusive. A reason for this is that a coupling ratio contributing to the fixation strength of the electrode terminal 20 to the cover part 12 is made appropriate, which makes a balance between a sealing property and a releasing property regarding the outer package can 10 and the cover part 12 appropriate. In other words, it becomes easier for the electrode terminal 20 to serve as the release valve upon the occurrence of an abnormal condition, while the fixation strength of the electrode terminal 20 to the cover part 12 is secured in normal times. Note that a value of the fixation ratio is a value rounded off to two decimal places.

As illustrated in FIG. 1, the gasket 30 is an insulating sealing member interposed between the outer package can 10 (the cover part 12) and the electrode terminal 20, and the electrode terminal 20 is fixed to the cover part 12 via the gasket 30. Specifically, the gasket 30 is thermal-fusion-bonded to each of the cover part 12 and the electrode terminal 20. Thus, the electrode terminal 20 is thermally fixed to the cover part 12 with use of the gasket 30. Here, the gasket 30 has a ring planar shape having a through hole at a location corresponding to the through hole 12K.

The gasket 30 includes one or more of insulating materials including, without limitation, an insulating polymer compound. Specific examples of the insulating material include polypropylene and polyethylene.

In particular, the gasket 30 includes polypropylene, and a melting point of polypropylene is preferably within a range from 130° C. to 250° C. both inclusive. A reason for this is that a physical property of the gasket 30 is made appropriate, and thus, the balance between the sealing property and the releasing property regarding the outer package can 10 and the electrode terminal 20 is made appropriate. Accordingly, in normal times, the fixation strength of the electrode terminal 20 to the cover part 12 is secured, which makes it easier to seal the outer package can 10. Upon the occurrence of an abnormal condition, it becomes easier to cause the electrode terminal 20 to be separated from the cover part 12, which causes the internal pressure of the outer package can 10 to be released easily.

When the secondary battery is discharged at a large current, the temperature of the secondary battery can be increased up to about 80° C. Accordingly, in order to prevent the electrode terminal 20 from being unintentionally separated from the cover part 12 when the internal pressure is not excessively increased to such an extent that the outer package can 10 can rupture, that is, when the temperature of the secondary battery is increased only to about 80° C., a melting point of the gasket 30 is preferably within the above-described appropriate range.

A range over which the gasket 30 is to be provided is not particularly limited, and may thus be set as desired. Here, the gasket 30 is disposed inside the recessed part 12U between an upper surface of the cover part 12 and a lower surface of the electrode terminal 20.

The battery device 40 is an electric power generating device causing charging and discharging reactions to proceed, and is contained inside the outer package can 10, as illustrated in FIGS. 1 and 2. The battery device 40 includes the positive electrode 41, the negative electrode 42, a separator 43, and an unillustrated electrolytic solution that is a liquid electrolyte.

The battery device 40 to be described here is what is called a wound electrode body. That is, in the battery device 40, the positive electrode 41 and the negative electrode 42 are stacked on each other with the separator 43 interposed therebetween, and the stack of the positive electrode 41, the negative electrode 42, and the separator 43 is wound.

Thus, the positive electrode 41 and the negative electrode 42 are opposed to each other with the separator 43 interposed therebetween, and are wound. As a result, the battery device 40 has a winding center space 40S at a center around which the positive electrode 41 and the negative electrode 42 are wound. The winding center space 40S is a space that extends through the battery device 40 in a height direction, and none of components including the positive electrode 41, the negative electrode 42, and the separator 43 are present inside the winding center space 40S.

An inner diameter of the winding center space 40S is not particularly limited. In particular, the inner diameter of the winding center space 40S is preferably smaller than the inner diameter of the through hole 12K, and more preferably as small as possible. A reason for this is that, provided that the outer diameter D of the secondary battery is kept constant, the number of winds of each of the positive electrode 41 and the negative electrode 42 increases, and accordingly, the energy density per volume increases.

The winding center space 40S serves as a path for transmitting the internal pressure to the electrode terminal 20 through the through hole 12K upon the excessive rise in the internal pressure of the outer package can 10. Accordingly, the through hole 12K is preferably positioned to overlap a portion or all of the winding center space 40S. A reason for this is that the internal pressure is easily transmitted to the electrode terminal 20, which makes it easier for the electrode terminal 20 to operate as the release valve. FIG. 1 illustrates a case of positioning the through hole 12K in such a manner that the through hole 12K overlaps all of the winding center space 40S.

Note that “the through hole 12K overlaps all of the winding center space 40S” means that the through hole 12K and the winding center space 40S are positioned in such a manner that a portion of the through hole 12K and all of the winding center space 40S overlap each other where the secondary battery is viewed from above.

Here, the positive electrode 41, the negative electrode 42, and the separator 43 are wound in such a manner that the separator 43 is disposed in each of an outermost wind and an innermost wind. The number of winds of each of the positive electrode 41, the negative electrode 42, and the separator 43 is not particularly limited, and may thus be set as desired.

The battery device 40 has a three-dimensional shape similar to the three-dimensional shape of the outer package can 10, and therefore has a cylindrical three-dimensional shape. A reason for this is that this helps to prevent what is called a dead space (an excess space between the outer package can 10 and the battery device 40) from resulting upon placing the battery device 40 inside the outer package can 10, and to thereby allow the internal space of the outer package can 10 to be efficiently used, as compared with a case where the battery device 40 has a three-dimensional shape different from that of the outer package can 10. As a result, the device space volume increases and accordingly, the energy density per volume increases.

The positive electrode 41 includes, as illustrated in FIG. 2, a positive electrode current collector 41A and a positive electrode active material layer 41B.

The positive electrode current collector 41A has two opposed surfaces on each of which the positive electrode active material layer 41B is to be provided. The positive electrode current collector 41A includes an electrically conductive material such as a metal material. Examples of the metal material include aluminum.

Here, the positive electrode active material layer 41B is provided on each of the two opposed surfaces of the positive electrode current collector 41A. The positive electrode active material layer 41B includes one or more of positive electrode active materials into which lithium is insertable and from which lithium is extractable. Note that the positive electrode active material layer 41B may be provided only on one of the two opposed surfaces of the positive electrode current collector 41A, on a side on which the positive electrode 41 is opposed to the negative electrode 42. In addition, the positive electrode active material layer 41B may further include materials including, without limitation, a positive electrode binder and a positive electrode conductor. A method of forming the positive electrode active material layer 41B is not particularly limited, and is specifically a method such as a coating method.

The positive electrode active material includes a lithium compound. The lithium compound is a compound including lithium as a constituent element, and is more specifically a compound including lithium and one or more transition metal elements as constituent elements. A reason for this is that a high energy density is obtainable. Note that the lithium compound may further include one or more other elements (elements other than lithium and the transition metal elements). The lithium compound is not particularly limited in kind, and is specifically an oxide, a phosphoric acid compound, a silicic acid compound, or a boric acid compound, for example. Specific examples of the oxide include LiNiO₂, LiCoO₂, and LiMn₂O₄. Specific examples of the phosphoric acid compound include LiFePO₄ and LiMnPO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride. The positive electrode conductor includes one or more of electrically conductive materials including, without limitation, a carbon material. Examples of the carbon material include graphite, carbon black, acetylene black, and Ketjen black. The electrically conductive material may be a metal material or a polymer compound, for example.

The negative electrode 42 includes, as illustrated in FIG. 2, a negative electrode current collector 42A and a negative electrode active material layer 42B.

The negative electrode current collector 42A has two opposed surfaces on each of which the negative electrode active material layer 42B is to be provided. The negative electrode current collector 42A includes an electrically conductive material such as a metal material. Examples of the metal material include copper.

Here, the negative electrode active material layer 42B is provided on each of the two opposed surfaces of the negative electrode current collector 42A. The negative electrode active material layer 42B includes one or more of negative electrode active materials into which lithium is insertable and from which lithium is extractable. Note that the negative electrode active material layer 42B may be provided only on one of the two opposed surfaces of the negative electrode current collector 42A, on a side on which the negative electrode 42 is opposed to the positive electrode 41. In addition, the negative electrode active material layer 42B may further include materials including, without limitation, a negative electrode binder and a negative electrode conductor. Details of the negative electrode binder are similar to those of the positive electrode binder. Details of the negative electrode conductor are similar to those of the positive electrode conductor. A method of forming the negative electrode active material layer 42B is not particularly limited, and specifically includes one or more of methods including, without limitation, a coating method, a vapor-phase method, a liquid-phase method, a thermal spraying method, and a firing (sintering) method.

The negative electrode active material includes a carbon material, a metal-based material, or both, for example. A reason for this is that a high energy density is obtainable. Examples of the carbon material include graphitizable carbon, non-graphitizable carbon, and graphite (natural graphite and artificial graphite). The metal-based material is a material that includes, as one or more constituent elements, one or more elements among metal elements and metalloid elements that are each able to form an alloy with lithium. Specific examples of such metal elements and metalloid elements include silicon, tin, or both. Note that the metal-based material may be a simple substance, an alloy, a compound, a mixture of two or more thereof, or a material including two or more phases thereof. Specific examples of the metal-based material include TiSi₂ and SiOₓ (0 < × ≤ 2 or 0.2 < ×< 1.4).

Here, the negative electrode 42 has a height greater than a height of the positive electrode 41. In this case, the negative electrode 42 protrudes upward from the positive electrode 41, and also protrudes downward from the positive electrode 41. A reason for this is to prevent precipitation of lithium, which has been extracted from the positive electrode 41, on a surface of the negative electrode 42.

The separator 43 is an insulating porous film interposed between the positive electrode 41 and the negative electrode 42 as illustrated in FIG. 2, and allows lithium ions to pass therethrough while preventing a short circuit between the positive electrode 41 and the negative electrode 42. The separator 43 includes a polymer compound such as polyethylene.

Here, the separator 43 has a height greater than the height of the negative electrode 42. In this case, the separator 43 protrudes upward from the negative electrode 42, and also protrudes downward from the negative electrode 42. A reason for this is to prevent contact between the positive electrode 41 and the outer package can 10 (the container part 11 and the cover part 12).

The positive electrode 41, the negative electrode 42, and the separator 43 are each impregnated with the electrolytic solution. The electrolytic solution includes a solvent and an electrolyte salt. The solvent includes one or more of non-aqueous solvents (organic solvents) including, without limitation, a carbonic-acid-ester-based compound, a carboxylic-acid-ester-based compound, and a lactone-based compound. An electrolytic solution including any of the non-aqueous solvents is what is called a non-aqueous electrolytic solution. The electrolyte salt includes one or more of light metal salts including, without limitation, a lithium salt.

As illustrated in FIG. 1, the positive electrode lead 50 is a wiring member that is contained inside the outer package can 10, and couples the positive electrode 41 of the battery device 40 and the electrode terminal 20 to each other. Specifically, the positive electrode lead 50 is coupled to the positive electrode current collector 41A of the positive electrode 41, and is also coupled to the electrode terminal 20 through the through hole 12K provided in the cover part 12.

Here, the secondary battery includes one positive electrode lead 50. Note that the secondary battery may include two or more positive electrode leads 50. As the number of positive electrode leads 50 increases, electric resistance of the battery device 40 decreases.

Details of a material included in the positive electrode lead 50 are similar to the details of the material included in the positive electrode current collector 41A. Note that the material included in the positive electrode lead 50 and the material included in the positive electrode current collector 41A may be the same as or different from each other.

A position, in the positive electrode 41, at which the positive electrode lead 50 is to be coupled is not particularly limited, and may thus be set as desired. In other words, the positive electrode lead 50 may be coupled to the positive electrode 41 in the outermost wind, may be coupled to the positive electrode 41 in the innermost wind, or may be coupled to the positive electrode 41 at any point of winding between the outermost wind and the innermost wind. FIG. 1 illustrates a case where the positive electrode lead 50 is coupled to the positive electrode 41 in the outermost wind.

Here, the positive electrode lead 50 is physically separated from the positive electrode current collector 41A and thereby provided as a component separate from the positive electrode current collector 41A. Thus, the positive electrode lead 50 is coupled to the positive electrode current collector 41A by a method such as a welding method. Note that the positive electrode lead 50 may be physically continuous with the positive electrode current collector 41A and thereby integrated with the positive electrode current collector 41A.

Note that a manner of routing of the positive electrode lead 50 between the positive electrode 41 and the electrode terminal 20 is not particularly limited. In particular, the positive electrode lead 50 is preferably bent between the positive electrode 41 and the electrode terminal 20, and is more preferably folded once or more at any point or points between the positive electrode 41 and the electrode terminal 20.

In other words, it is preferable that the positive electrode lead 50 extend from the positive electrode 41 to the electrode terminal 20 not in a shortest route between the positive electrode 41 and the electrode terminal 20, and that the positive electrode lead 50 extend from the positive electrode 41 to the electrode terminal 20 while bypassing the shortest route at any point or points between the positive electrode 41 and the electrode terminal 20.

A reason for this is that this ensures an excess portion of the positive electrode lead 50, i.e., creates a margin for the length of the positive electrode lead 50. This helps to prevent the electrode terminal 20 from becoming less separable from the cover part 12 by being unintentionally pulled by the positive electrode lead 50 upon the excessive rise in the internal pressure of the outer package can 10. This makes it easier for the electrode terminal 20 to operate as the release valve. FIG. 1 illustrates a case where the positive electrode lead 50 is folded only once at any point between the positive electrode 41 and the electrode terminal 20. Here, the positive electrode lead 50 extends to a position beyond the winding center space 40S, and is thereafter folded to be coupled to the electrode terminal 20.

As illustrated in FIG. 1, the negative electrode lead 60 is a member that is contained inside the outer package can 10, and couples the negative electrode 42 of the battery device 40 and the outer package can 10 to each other. Specifically, in other words, the negative electrode lead 60 is coupled to the negative electrode current collector 42A of the negative electrode 42, and is also coupled to the container part 11 of the outer package can 10.

Here, the secondary battery includes one negative electrode lead 60. Note that the secondary battery may include two or more negative electrode leads 60. As the number of negative electrode leads 60 increases, the electric resistance of the battery device 40 decreases.

Details of a material included in the negative electrode lead 60 are similar to the details of the material included in the negative electrode current collector 42A. Note that the material included in the negative electrode lead 60 and the material included in the negative electrode current collector 42A may be the same as or different from each other.

A position, in the negative electrode 42, at which the negative electrode lead 60 is to be coupled is not particularly limited, and may thus be set as desired. In other words, the negative electrode lead 60 may be coupled to the negative electrode 42 in the outermost wind, may be coupled to the negative electrode 42 in the innermost wind, or may be coupled to the negative electrode 42 at any point of winding between the outermost wind and the innermost wind. FIG. 1 illustrates a case where the negative electrode lead 60 is coupled to the negative electrode 42 in the outermost wind.

Here, the negative electrode lead 60 is physically separated from the negative electrode current collector 42A and thereby provided as a component separate from the negative electrode current collector 42A. Thus, the negative electrode lead 60 is coupled to the negative electrode current collector 42A by a method such as a welding method. Note that the negative electrode lead 60 may be physically continuous with the negative electrode current collector 42A and thereby integrated with the negative electrode current collector 42A.

Note that a manner of routing of the negative electrode lead 60 between the negative electrode 42 and the container part 11 is not particularly limited, and may thus be set as desired.

The insulating plates 71 and 72 are disposed to sandwich the battery device 40 in the height direction, and are thus opposed to each other with the battery device 40 interposed therebetween. The insulating plates 71 and 72 each include one or more of insulating materials including, without limitation, polyimide. Note that the insulating plate 71 has a through hole 71K positioned to overlap a portion or all of the winding center space 40S. FIG. 1 illustrates a case where the through hole 71K is larger than the winding center space 40S in inner diameter and overlaps all of the winding center space 40S.

The sealant 73 is a member protecting a perimeter of the positive electrode lead 50, and is what is called a protective tape. The sealant 73 has a tube-shaped structure to cover the perimeter of the positive electrode lead 50, and includes one or more of insulating polymer compounds including, without limitation, polypropylene, polyethylene terephthalate, and polyimide. The positive electrode lead 50 is thus insulated from the outer package can 10 (the cover part 12) and the battery device 40 (the negative electrode 42) via the sealant 73. Note that a range over which the positive electrode lead 50 is to be covered with the sealant 73 is not particularly limited, and may thus be set as desired.

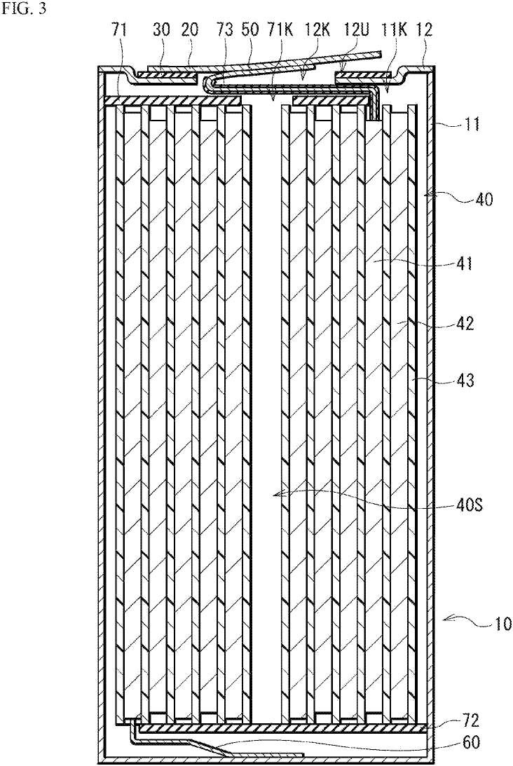

FIG. 3 illustrates a sectional configuration corresponding to FIG. 1 for describing an operation of the secondary battery. In the following, an operation at the time of charging and discharging is described, and then, the operation at the time when an abnormal condition occurs is described.

Upon charging, in the battery device 40, lithium is extracted from the positive electrode 41, and the extracted lithium is inserted into the negative electrode 42 via the electrolytic solution. Upon discharging, in the battery device 40, lithium is extracted from the negative electrode 42, and the extracted lithium is inserted into the positive electrode 41 via the electrolytic solution. Upon charging and discharging, lithium is inserted and extracted in an ionic state.

Upon the excessive rise in the internal pressure of the outer package can 10, the electrode terminal 20 is strongly pushed toward the outer side by the internal pressure, as described above. Accordingly, as illustrated in FIG. 3, the electrode terminal 20 is separated from the cover part 12. As a result, the internal pressure is released through the gap that is developed between the electrode terminal 20 and the cover part 12, which suppresses, for example, a rupture of the outer package can 10. FIG. 3 illustrates a case where the electrode terminal 20 is separated in part from the cover part 12.

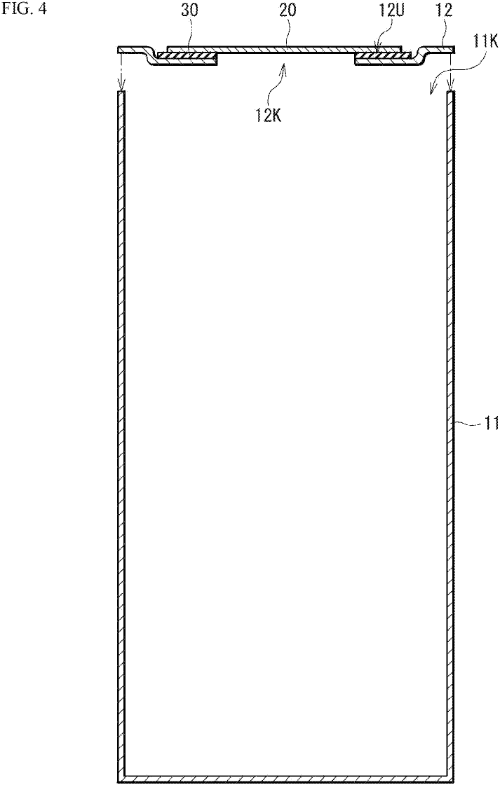

FIG. 4 illustrates a sectional configuration corresponding to FIG. 1 for describing a process of manufacturing the secondary battery. Note that FIG. 4 illustrates a state in which the container part 11 and the cover part 12 are separated from each other. In the following description, reference is made to FIGS. 1 and 2 which have already been described, together with FIG. 4, where appropriate.

In a case of manufacturing the secondary battery, the positive electrode 41 and the negative electrode 42 are fabricated and the electrolytic solution is prepared by respective procedures to be described below, following which the positive electrode 41, the negative electrode 42, and the electrolytic solution are used to assemble the secondary battery.

Here, as illustrated in FIG. 4, the container part 11 and the cover part 12 that are physically separated from each other are used to form the outer package can 10. The container part 11 has, as described above, the opening 11K. To the cover part 12 having the recessed part 12U, the electrode terminal 20 is fixed in advance via the gasket 30, as described above.

First, a positive electrode mixture in which, for example, the positive electrode active material, the positive electrode binder, and the positive electrode conductor are mixed with each other is put into a solvent to thereby prepare a positive electrode mixture slurry in a paste form. The solvent may be an aqueous solvent, or may be an organic solvent. Details of the solvent described here apply also to the following. Thereafter, the positive electrode mixture slurry is applied on the two opposed surfaces of the positive electrode current collector 41A to thereby form the positive electrode active material layers 41B. Lastly, the positive electrode active material layers 41B may be compression-molded by means of, for example, a roll pressing machine. In this case, the positive electrode active material layers 41B may be heated. The positive electrode active material layers 41B may be compression-molded multiple times. In this manner, the positive electrode active material layers 41B are formed on the respective two opposed surfaces of the positive electrode current collector 41A. Thus, the positive electrode 41 is fabricated.

First, a negative electrode mixture in which, for example, the negative electrode active material, the negative electrode binder, and the negative electrode conductor are mixed with each other is put into a solvent to thereby prepare a negative electrode mixture slurry in a paste form. Thereafter, the negative electrode mixture slurry is applied on the two opposed surfaces of the negative electrode current collector 42A to thereby form the negative electrode active material layers 42B. Lastly, the negative electrode active material layers 42B may be compression-molded by means of, for example, a roll pressing machine. Details of the compression molding of the negative electrode active material layers 42B are similar to the details of the compression molding of the positive electrode active material layers 41B. In this manner, the negative electrode active material layers 42B are formed on the respective two opposed surfaces of the negative electrode current collector 42A. Thus, the negative electrode 42 is fabricated.

The electrolyte salt is put into the solvent. The electrolyte salt is thereby dispersed or dissolved in the solvent. As a result, the electrolytic solution is prepared.

First, by means of a method such as a welding method, the positive electrode lead 50 whose perimeter is covered in part with the sealant 73 is coupled to the positive electrode current collector 41A of the positive electrode 41. Further, by means of a method such as a welding method, the negative electrode lead 60 is coupled to the negative electrode current collector 42A of the negative electrode 42. The welding method includes one or more of methods including, without limitation, a resistance welding method and a laser welding method. Details of the welding method described here apply also to the following.

Thereafter, the positive electrode 41 to which the positive electrode lead 50 is coupled and the negative electrode 42 to which the negative electrode lead 60 is coupled are stacked on each other with the separator 43 interposed therebetween. Thereafter, the positive electrode 41, the negative electrode 42, and the separator 43 are wound to thereby fabricate an unillustrated wound body having the winding center space 40S. The wound body has a configuration similar to that of the battery device 40 except that the positive electrode 41, the negative electrode 42, and the separator 43 are each not impregnated with the electrolytic solution.

Thereafter, the insulating plates 71 and 72 are disposed in such a manner as to oppose each other with the wound body interposed therebetween, following which the insulating plates 71 and 72, together with the wound body, are placed into the container part 11 through the opening 11K. In this case, the negative electrode lead 60 is coupled to the container part 11 by a method such as a welding method.

Thereafter, the electrolytic solution is injected into the container part 11 through the opening 11K. The wound body including the positive electrode 41, the negative electrode 42, and the separator 43 is thereby impregnated with the electrolytic solution. The battery device 40 is thus fabricated. In this case, some of the electrolytic solution is supplied to an inside of the winding center space 40S, and accordingly, the wound body is impregnated with the electrolytic solution from the inside of the winding center space 40S.

Thereafter, the opening 11K is covered with the cover part 12 to which the electrode terminal 20 is fixed via the gasket 30, following which the cover part 12 is welded to the container part 11 by a welding method. In this case, the positive electrode lead 50 is coupled to the electrode terminal 20 through the through hole 12K by a method such as a welding method.

Accordingly, the container part 11 and the cover part 12 are welded to each other to thereby form the outer package can 10, and the battery device 40 and other components are placed into the outer package can 10. As a result, the secondary battery is assembled.

The assembled secondary battery is charged and discharged. Conditions including, for example, an environment temperature, the number of times of charging and discharging (the number of cycles), and charging and discharging conditions may be set as desired. A film is thereby formed on a surface of a location such as the negative electrode 42. This brings the secondary battery into an electrochemically stable state.

The battery device 40 and other components are thus sealed in the outer package can 10. As a result, the secondary battery is completed.

According to the secondary battery, the battery device 40 is contained inside the outer package can 10 whose aspect ratio (outer diameter D/height H) is greater than or equal to 0.1 and less than 1, and, in the outer package can 10, the cover part 12 having the through hole 12K is welded to the container part 11. Further, the electrode terminal 20 is fixed to the cover part 12 via the gasket 30, and the fixation strength of the electrode terminal 20 to the cover part 12 is lower than the welding strength of the cover part 12 to the container part 11. Accordingly, it is possible to achieve a superior battery capacity characteristic and superior safety for the following reasons.

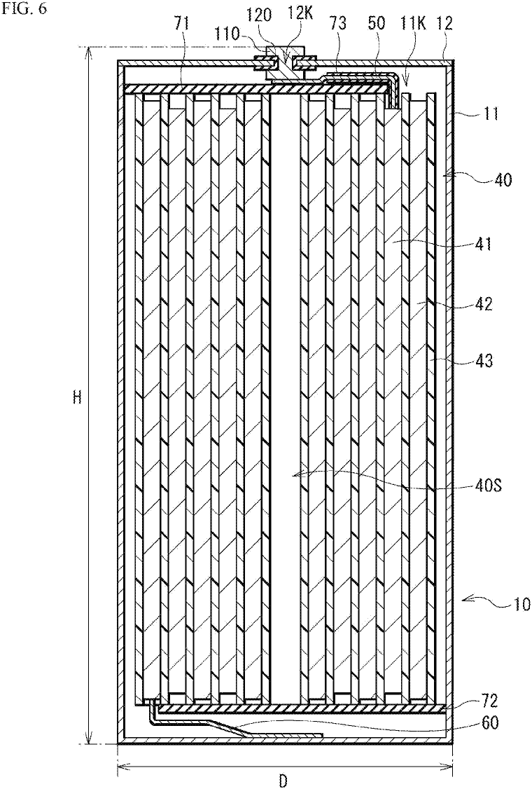

FIG. 5 illustrates a sectional configuration of a secondary battery according to a first comparative example, and corresponds to FIG. 1. FIG. 6 illustrates a sectional configuration of a secondary battery according to a second comparative example, and corresponds to FIG. 1.

As illustrated in FIG. 5, the secondary battery of the first comparative example has a configuration similar to that of the secondary battery of the embodiment illustrated in FIG. 1, except for the following.

The secondary battery of the first comparative example differs from the secondary battery of the embodiment including the outer package can 10 that is the welded can (the crimpless can), in that the secondary battery of the first comparative example includes the outer package can 80 that is a crimped can. In addition, the secondary battery of the first comparative example further includes a battery cover 91, the safety valve mechanism 92, the thermosensitive resistive device (the PTC device) 93, and a gasket 94.

The outer package can 80 has a hollow cylindrical three-dimensional shape with one end part closed and another end part open. Note that a material included in the outer package can 80 is similar to that included in the outer package can 10.

In the one end part of the outer package can 80 that is open, i.e., in an open end, the battery cover 91, the safety valve mechanism 92, and the PTC device 93 are crimped via the gasket 94. Thus, each of the battery cover 91, the safety valve mechanism 92, and the PTC device 93 is fixed to the outer package can 80, and the open end of the outer package can 80 is sealed by the battery cover 91. A material included in the battery cover 91 is similar to that included in the outer package can 80. Each of the safety valve mechanism 92 and the PTC device 93 is provided on an inner side of the battery cover 91, and the safety valve mechanism 92 is electrically coupled to the battery cover 91 via the PTC device 93. The gasket 94 includes an insulating material such as polypropylene.

In the safety valve mechanism 92, a disk plate 92A inverts upon an excessive rise in an internal pressure of the outer package can 80, thereby releasing the internal pressure and cutting off the electrical coupling between the battery cover 91 and the battery device 40. The PTC device 93 involves an increase in electric resistance in accordance with a rise in temperature, in order to prevent abnormal heat generation resulting from a large current.

As illustrated in FIG. 6, the secondary battery of the second comparative example has a configuration similar to that of the secondary battery of the embodiment illustrated in FIG. 1, except for the following.

The secondary battery of the second comparative example is similar to the secondary battery of the embodiment in that the secondary battery of the second comparative example includes the outer package can 10 that is the welded can (the crimpless can), except that the cover part 12 is not provided with the recessed part 12U. In addition, the secondary battery of the second comparative example includes an electrode terminal 110 and a gasket 120 instead of the electrode terminal 20 and the gasket 30.

The electrode terminal 110 is fixed to the cover part 12 via the gasket 120, and has what is called a rivet three-dimensional shape. Specifically, the electrode terminal 110 includes a small outer diameter portion, and a pair of large outer diameter portions coupled to the small outer diameter portion. The small outer diameter portion is disposed in the through hole 12K, and has an outer diameter smaller than the inner diameter of the through hole 12K. One of the large outer diameter portions is disposed on the outer side of the cover part 12, and has an outer diameter larger than the inner diameter of the through hole 12K. Another of the large outer diameter portions is disposed on the inner side of the cover part 12, and has an outer diameter larger than the inner diameter of the through hole 12K. Accordingly, the electrode terminal 110 is fixed to the cover part 12 via the gasket 120 with use of a pressing force of the pair of large outer diameter portions on the cover part 12.

The gasket 120 is interposed between the cover part 12 and the electrode terminal 110, and the electrode terminal 110 is thus insulated from the cover part 12 via the gasket 120. Details of a material included in the gasket 120 are similar to the details of the material included in the gasket 30.

The secondary battery of the first comparative example includes the safety valve mechanism 92, as illustrated in FIG. 5. In this case, upon the excessive rise in the internal pressure of the outer package can 80, the pressure is released with use of the safety valve mechanism 92, as described above. This suppresses, for example, a rupture of the outer package can 80, and superior safety is therefore achievable.

However, in the secondary battery of the first comparative example, not only the battery device 40 but also special mechanisms and devices including, without limitation, the safety valve mechanism 92 and the PTC device 93 are contained inside the outer package can 80. In this case, provided that the height H of the secondary battery is kept constant, the device space volume is reduced by a volume of the above-described special mechanisms and devices contained inside the outer package can 80, and more specifically, a height of the battery device 40 decreases. The device space volume is therefore reduced. Accordingly, the battery capacity decreases due to the decrease in the volume energy density. The battery capacity characteristic therefore deteriorates.

From the foregoing, according to the secondary battery of the first comparative example, it is possible to achieve superior safety; however, the battery capacity characteristic deteriorates. Thus, the battery capacity characteristic and the safety are incompatible with each other. Accordingly, it is difficult to achieve both a superior battery capacity characteristic and superior safety.

The secondary battery of the second comparative example does not include the special mechanisms and devices such as the safety valve mechanism 92 or the PTC device 93, as illustrated in FIG. 6. Thus, the special mechanisms and devices do not have to be contained inside the outer package can 10. In this case, provided that the height H of the secondary battery is kept constant, the device space volume increases by the volume of the special mechanisms and devices that are not contained inside the outer package can 10, and more specifically, the height of the battery device 40 increases. The device space volume therefore increases. As a result, the battery capacity increases in accordance with an increase in the volume energy density, and a superior battery capacity characteristic is therefore achievable.

However, the secondary battery of the second comparative example is unable to release the internal pressure even if the internal pressure of the outer package can 10 excessively rises. This causes, for example, the rupture of the outer package can 10 to occur, and the safety therefore deteriorates.

From the foregoing, according to the secondary battery of the second comparative example, it is possible to achieve a superior battery capacity characteristic; however, the safety deteriorates. Thus, the battery capacity characteristic and the safety are incompatible with each other. Accordingly, as with the secondary battery of the first comparative example, it is difficult to achieve both a superior battery capacity characteristic and superior safety.

In contrast, the secondary battery of the embodiment does not include the special mechanisms and devices such as the safety valve mechanism 92 or the PTC device 93, as illustrated in FIG. 1. Thus, the special mechanisms and devices do not have to be contained inside the outer package can 10. In this case, as described above, provided that the height H of the secondary battery is kept constant, the device space volume increases by the volume of the special mechanisms and devices that are not contained inside the outer package can 10. The device space volume therefore increases. As a result, the battery capacity increases in accordance with an increase in the volume energy density, and a superior battery capacity characteristic is therefore achievable.

Moreover, upon the excessive rise in the internal pressure of the outer package can 10, the electrode terminal 20 serves as a safety valve as described above, and thus the internal pressure is released with use of the electrode terminal 20. In this case, in particular, the fixation strength of the electrode terminal 20 to the cover part 12 is lower than the welding strength of the cover part 12 to the container part 11. This makes it easier for the electrode terminal 20 to operate as the release valve prior to the rupture of the outer package can 10, as described above. Further, the aspect ratio is greater than or equal to 0.1 and less than 1. This makes it easier for the electrode terminal 20 to serve stably as the release valve while the volume energy density is secured, as described above. As a result, the rupture of the outer package can 10, for example, is suppressed, and superior safety is therefore also achievable.

From the foregoing, according to the secondary battery of the embodiment, it is possible to achieve not only a superior battery capacity characteristic, but also superior safety. Thus, the battery capacity characteristic and the safety are compatible with each other. It is therefore possible to achieve both a superior battery capacity characteristic and superior safety.

In particular, according to the secondary battery of the embodiment, the aspect ratio may be less than or equal to 0.6. This further increases the volume energy density and accordingly further improves the battery capacity characteristic. It is therefore possible to achieve higher effects.

Further, the fixation ratio may be within the range from 1.13 to 3.37 both inclusive. This makes the balance between the sealing property and the releasing property regarding the outer package can 10 and the electrode terminal 20 appropriate. Accordingly, it becomes easier for the electrode terminal 20 to serve as the release valve upon the occurrence of an abnormal condition, while the fixation strength of the electrode terminal 20 to the cover part 12 is secured in normal times. It is therefore possible to achieve higher effects.

Further, the electrode terminal 20 may be disposed on the outer side of the cover part 12. This makes it easier to cause the electrode terminal 20 to be separated from the cover part 12 upon the excessive rise in the internal pressure of the outer package can 10. It is therefore possible to achieve higher effects.

Further, the gasket 30 may include polypropylene having the melting point within the range from 130° C. to 250° C. both inclusive. This makes the balance between the sealing property and the releasing property regarding the outer package can 10 and the electrode terminal 20 appropriate. Accordingly, it becomes easier for the electrode terminal 20 to serve as the release valve upon the occurrence of an abnormal condition, while the fixation strength of the electrode terminal 20 to the cover part 12 is secured in normal times. It is therefore possible to achieve higher effects.

Further, the battery device 40 may have the winding center space 40S, and the through hole 12K may be positioned to overlap a portion or all of the winding center space 40S. This allows the internal pressure to be easily transmitted to the electrode terminal 20. Accordingly, it becomes easier for the electrode terminal 20 to operate as the release valve. It is therefore possible to achieve higher effects.

In this case, the inner diameter of the through hole 12K may be larger than the inner diameter of the winding center space 40S. This increases the exposed area of the electrode terminal 20 in the through hole 12K. Accordingly, it becomes further easier for the electrode terminal 20 to operate as the release valve. It is therefore possible to achieve further higher effects.

Further, the positive electrode lead 50 may be folded once or more between the positive electrode 41 and the electrode terminal 20. This creates a margin for the length of the positive electrode lead 50. Accordingly, it becomes easier for the electrode terminal 20 to operate as the release valve free of influence from the positive electrode lead 50. It is therefore possible to achieve higher effects.

Further, the cover part 12 may have the recessed part 12U that protrudes in part toward the inside of the container part 11, and the electrode terminal 20 may be disposed inside the recessed part 12U. This decreases the height H of the secondary battery, and accordingly increases the energy density per volume. It is therefore possible to achieve higher effects.

Further, the positive electrode 41 may be electrically coupled to the electrode terminal 20, and the negative electrode 42 may be electrically coupled to the outer package can 10. This makes it unnecessary for the secondary battery to additionally include the external coupling terminal of the positive electrode 41 and the external coupling terminal of the negative electrode 42. The device space volume thus increases, and the volume energy density accordingly increases. It is therefore possible to achieve higher effects.

Further, the secondary battery may include the secondary battery of the cylindrical type. This sufficiently decreases the aspect ratio and accordingly sufficiently increases the volume energy density. It is therefore possible to achieve higher effects.

Further, the secondary battery may include a lithium-ion secondary battery. This makes it possible to obtain a sufficient battery capacity stably through the use of insertion and extraction of lithium. It is therefore possible to achieve higher effects.

The configuration of the secondary battery described herein is appropriately modifiable including as described in further detail below according to an embodiment.. Note that any two or more of the following series of modifications may be combined with each other.

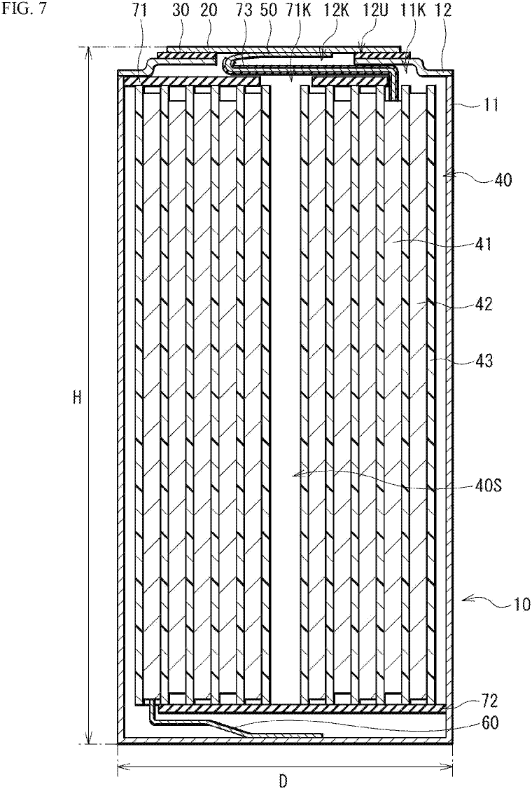

In FIG. 1, the cover part 12 bends to protrude in part toward the inside, i.e., in the downward direction, of the container part 11, thereby being provided with the recessed part 12U. However, as illustrated in FIG. 7 corresponding to FIG. 1, the recessed part 12U may be formed by bending the cover part 12 to protrude in part toward the outside, i.e., in an upward direction, of the container part 11. In this case also, as with the case illustrated in FIG. 1, the volume energy density increases, making it possible to achieve a superior battery capacity characteristic, and the electrode terminal 20 serves as the release valve, making it possible to achieve superior safety. Accordingly, it is possible to achieve similar effects.

However, provided that the height H of the secondary battery is kept constant, the recessed part 12U that protrudes toward the outside of the container part 11 (FIG. 7) can have a reduced volume energy density due to a reduction in the device space volume, as compared with the recessed part 12U that protrudes toward the inside of the container part 11 (FIG. 1). Thus, in order to increase the device space volume and accordingly to increase the volume energy density, the recessed part 12U preferably protrudes toward the inside of the container part 11 rather than toward the outside of the container part 11.

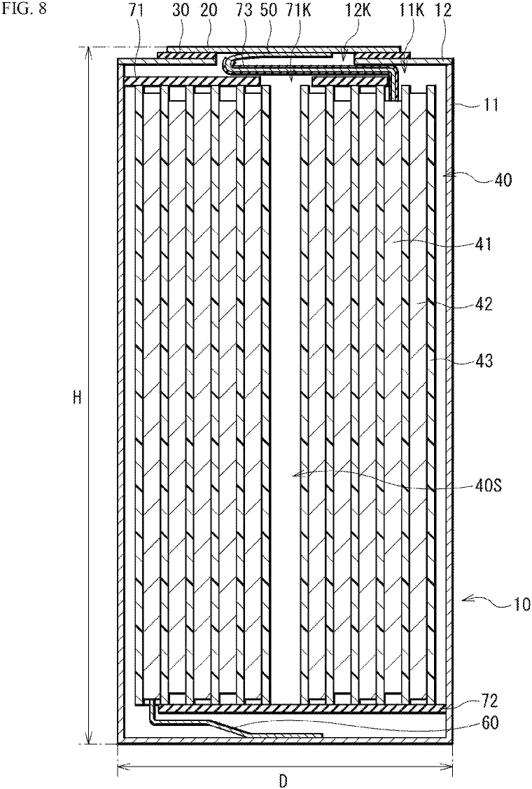

In FIG. 1, the cover part 12 has the recessed part 12U and the electrode terminal 20 is disposed on the outer side of the cover part 12, and thus, the electrode terminal 20 is contained inside the recessed part 12U. However, as illustrated in FIG. 8 corresponding to FIG. 1, the cover part 12 may not have the recessed part 12U, and the electrode terminal 20 may be disposed on the outer side of the cover part 12. In this case also, as with the case illustrated in FIG. 1, it is possible to achieve a superior battery capacity characteristic and superior safety, and similar effects are therefore obtainable.

In FIG. 1, the positive electrode 41 is coupled to the electrode terminal 20 via the positive electrode lead 50, and the negative electrode 42 is coupled to the outer package can 10 (the container part 11) via the negative electrode lead 60. Thus, the electrode terminal 20 serves as the external coupling terminal of the positive electrode 41, and the outer package can 10 serves as the external coupling terminal of the negative electrode 42.

However, although not specifically illustrated here, the positive electrode 41 may be coupled to the outer package can 10 (the container part 11) via the positive electrode lead 50, and the negative electrode 42 may be coupled to the electrode terminal 20 via the negative electrode lead 60. Thus, the electrode terminal 20 may serve as the external coupling terminal of the negative electrode 42, and the outer package can 10 may serve as the external coupling terminal of the positive electrode 41.

In this case also, as with the case illustrated in FIG. 1, the secondary battery does not have to additionally include the external coupling terminal of the positive electrode 41 and the external coupling terminal of the negative electrode 42. The device space volume thus increases, and the volume energy density accordingly increases. It is therefore possible to achieve similar effects.

In this case, the negative electrode lead 60 is preferably coupled to the electrode terminal 20 through the winding center space 40S, in particular. A reason for this is that this prevents a decrease in the number of winds of each of the positive electrode 41 and the negative electrode 42 due to the manner of routing of the negative electrode lead 60, and thus secures the battery capacity. Note that, in order to guide the negative electrode lead 60 into the winding center space 40S, a through hole for passing the negative electrode lead 60 may be provided in the insulating plate 72.

The separator 43 that is a porous film is used. However, although not specifically illustrated here, a separator of a stacked type including a polymer compound layer may be used.

Specifically, the separator of the stacked type includes a porous film having two opposed surfaces, and the polymer compound layer provided on one of or each of the two opposed surfaces of the porous film. A reason for this is that adherence of the separator to each of the positive electrode 41 and the negative electrode 42 improves to suppress the occurrence of misalignment (irregular winding) of the battery device 40. This helps to prevent the secondary battery from easily swelling even if, for example, the decomposition reaction of the electrolytic solution occurs. The polymer compound layer includes a polymer compound such as polyvinylidene difluoride. A reason for this is that the polymer compound such as polyvinylidene difluoride has superior physical strength and is electrochemically stable.

Note that the porous film, the polymer compound layer, or both may each include one or more kinds of insulating particles. A reason for this is that the insulating particles dissipate heat upon heat generation by the secondary battery, thus improving safety or heat resistance of the secondary battery. The insulating particles include an inorganic material, a resin material, or both. Specific examples of the inorganic material include aluminum oxide, aluminum nitride, boehmite, silicon oxide, titanium oxide, magnesium oxide, and zirconium oxide. Specific examples of the resin material include an acrylic resin and a styrene resin.

In a case of fabricating the separator of the stacked type, a precursor solution including, without limitation, the polymer compound and a solvent is prepared, following which the precursor solution is applied on one of or each of the two opposed surfaces of the porous film. In this case, insulating particles may be added to the precursor solution on an as-needed basis.

When the separator of the stacked type is used also, lithium ions are movable between the positive electrode 41 and the negative electrode 42, and similar effects are therefore obtainable. In this case, in particular, the safety of the secondary battery improves as described above. It is therefore possible to achieve higher effects.

The electrolytic solution that is a liquid electrolyte is used. However, although not specifically illustrated here, an electrolyte layer which is a gel electrolyte may be used.

In the battery device 40 including the electrolyte layer, the positive electrode 41 and the negative electrode 42 are stacked on each other with the separator 43 and the electrolyte layer interposed therebetween, and the stack of the positive electrode 41, the negative electrode 42, the separator 43, and the electrolyte layer is wound. The electrolyte layer is interposed between the positive electrode 41 and the separator 43, and between the negative electrode 42 and the separator 43.

The electrolyte layer, for example, includes a polymer compound together with the electrolytic solution. The electrolytic solution is held by the polymer compound. A reason for this is that leakage of the electrolytic solution is prevented. The configuration of the electrolytic solution is as described above. The polymer compound includes, for example, polyvinylidene difluoride. In a case of forming the electrolyte layer, a precursor solution including, for example, the electrolytic solution, the polymer compound, and a solvent is prepared, following which the precursor solution is applied on one side or both sides of the positive electrode 41 and on one side or both sides of the negative electrode 42.

In a case where the electrolyte layer is used also, lithium ions are movable between the positive electrode 41 and the negative electrode 42 via the electrolyte layer, and similar effects are therefore obtainable. In this case, in particular, the leakage of the electrolytic solution is prevented as described above. It is therefore possible to achieve higher effects.

### EXAMPLES

A description is given of Examples of the present technology according to an embodiment.

### Experiment Examples 1 to 4 and Comparative Examples 1 to 5

Secondary batteries were fabricated, following which the secondary batteries were each evaluated for a battery characteristic as described below.

### [Fabrication of Secondary Battery]

Lithium-ion secondary batteries of a cylindrical type illustrated in FIGS. 1 and 2 were fabricated in accordance with the following procedure.

### (Fabrication of Positive Electrode)

First, 91 parts by mass of the positive electrode active material (LiNi_{0.8}Co_{0.15}Al_{0.05}O₂ that was a lithium-containing compound (the oxide)), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into a solvent (N-methyl-2-pyrrolidone that was the organic solvent), following which the solvent was stirred to thereby prepare a positive electrode mixture slurry in a paste form. Thereafter, the positive electrode mixture slurry was applied on the two opposed surfaces of the positive electrode current collector 41A (aluminum, having a thickness of 15 µm) by means of a coating apparatus, following which the applied positive electrode mixture slurry was dried to thereby form the positive electrode active material layers 41B. Lastly, the positive electrode active material layers 41B were compression-molded by means of a roll pressing machine. In this manner, the positive electrode 41 was fabricated.

### (Fabrication of Negative Electrode)

First, 93 parts by mass of the negative electrode active material (natural graphite that was the carbon material and silicon oxide (SiO) that was the metal-based material) and 7 parts by mass of the negative electrode binder (polyvinylidene difluoride) were mixed with each other to thereby obtain a negative electrode mixture. In this case, a mixture ratio (a weight ratio) of the negative electrode active material between natural graphite and silicon oxide was set to 93:7. Thereafter, the negative electrode mixture was put into a solvent (N-methyl-2-pyrrolidone that was the organic solvent), following which the solvent was stirred to thereby prepare a negative electrode mixture slurry in a paste form. Thereafter, the negative electrode mixture slurry was applied on the two opposed surfaces of the negative electrode current collector 42A (copper, having a thickness of 12 µm) by means of a coating apparatus, following which the applied negative electrode mixture slurry was dried to thereby form the negative electrode active material layers 42B. Lastly, the negative electrode active material layers 42B were compression-molded by means of a roll pressing machine. In this manner, the negative electrode 42 was fabricated.

### (Preparation of Electrolytic Solution)

The electrolyte salt (LiPF₆ that was the lithium salt) was added to the solvent (ethylene carbonate and diethyl carbonate that were each the carbonic-acid-ester-based compound), following which the solvent was stirred. In this case, a mixture ratio (a weight ratio) of the solvent between ethylene carbonate and diethyl carbonate was set to 30:70, and a content of the electrolyte salt was set to 1 mol/kg with respect to the solvent. In this manner, the electrolytic solution was prepared.

### (Assembly of Secondary Battery)

First, by means of a resistance welding method, the positive electrode lead 50 whose perimeter was covered in part with the sealant 73 (a polyimide tape) was welded to the positive electrode current collector 41A of the positive electrode 41. Further, by means of a resistance welding method, the negative electrode lead 60 was welded to the negative electrode current collector 42A of the negative electrode 42.

Thereafter, the positive electrode 41 and the negative electrode 42 were stacked on each other with the separator 43 interposed therebetween. The separator 43 included polyethylene, and had a thickness of 16 µm. Thereafter, the stack of the positive electrode 41, the negative electrode 42, and the separator 43 was wound to thereby fabricate the wound body having the winding center space 40S having an inner diameter of 3 mm.

Thereafter, the insulating plates 71 and 72 were disposed in such a manner as to oppose each other with the wound body interposed therebetween. The insulating plates 71 and 72 each included polyimide and had a thickness of 50 µm. Thereafter, the insulating plates 71 and 72, together with the wound body, were placed into the container part 11 having a cylindrical shape through the opening 11K. The container part 11 included iron plated with nickel, and had a thickness of 0.2 mm and an outer diameter of 18.2 mm. In this case, the negative electrode lead 60 was welded to the container part 11 by a resistance welding method.

Thereafter, the electrolytic solution was injected into the container part 11 through the opening 11K. The wound body was thereby impregnated with the electrolytic solution. The battery device 40 having the winding center space 40S was thus fabricated. The battery device 40 had an outer diameter of 17.5 mm and a height of 60 mm.

Thereafter, the opening 11K was covered with the cover part 12 having a plate shape (a substantially disk shape) to which the electrode terminal 20 having a plate shape (a disk shape) was fixed (thermal-fusion-bonded) via the gasket 30. The cover part 12 included SUS and had a thickness of 0.15 mm. The cover part 12 had the recessed part 12U having a circular shape and having an inner diameter of 16.2 mm, and the through hole 12K having an inner diameter of 13 mm. The electrode terminal 20 included aluminum, and had a thickness of 0.3 mm and an outer diameter of 15.85 mm. The gasket 30 included polypropylene and had a thickness of 0.07 mm. Thereafter, the cover part 12 was welded to the container part 11 by a laser welding method. In this case, the positive electrode lead 50 was welded to the electrode terminal 20 through the through hole 12K by a resistance welding method.

In such a manner, the outer package can 10 having a fixation ratio of 1.13 was formed using the container part 11 and the cover part 12, and the battery device 40 and other components were placed into the outer package can 10. As a result, the secondary battery was assembled.

When assembling the secondary battery, the aspect ratio was changed by varying the height H (mm) while keeping the outer diameter D constant to 18.2 mm. Details of the aspect ratio were as presented in Table 1.

### (Stabilization of Secondary Battery)

The assembled secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with the constant voltage of 4.2 V until a current reached 0.05 C. Upon discharging, the secondary battery was discharged with a constant current of 0.1 C until the voltage reached 2.5 V. Note that 0.1 C was a value of a current that caused a battery capacity (a theoretical capacity) to be completely discharged in 10 hours, and 0.05 C was a value of a current that caused the battery capacity to be completely discharged in 20 hours.

In this manner, the lithium-ion secondary battery of the cylindrical type including the outer package can 10 that was the welded can and the electrode terminal 20 having the plate shape was completed.

Note that the fixation strength (kgf/cm²) of the electrode terminal 20 to the cover part 12 and the welding strength (kgf/cm²) of the cover part 12 to the container part 11 were as presented in Table 1.

### [Fabrication of Other Secondary Batteries]

The secondary battery (the lithium-ion secondary battery) of the cylindrical type illustrated in FIG. 5 was fabricated for comparison, mainly by a similar procedure except that the outer package can 80 that was the crimped can was used instead of the outer package can 10 that was the welded can.

In this case, the battery cover 91, the safety valve mechanism 92, and the PTC device 93 were placed into the outer package can 80 having the open end. The outer package can 80 included iron plated with nickel and had a thickness of 0.2 mm. The battery cover 91 included iron plated with nickel and had a thickness of 0.3 mm. Thereafter, the open end of the outer package can 80 was crimped via the gasket 94 that included polypropylene and had a thickness of 0.45 mm. The battery cover 91, the safety valve mechanism 92, and the PTC device 93 were thereby fixed to the outer package can 80. A distance from an upper end of the battery cover 91 to a lower end of the safety valve mechanism 92 was 3.4 mm. In this case, the positive electrode lead 50 was welded to the safety valve mechanism 92 by a resistance welding method.

Further, the secondary battery (the lithium-ion secondary battery) of the cylindrical type illustrated in FIG. 6 was fabricated for comparison, mainly by a similar procedure except that: the outer package can 10 not provided with the recessed part 12U was used; and the electrode terminal 110 having a rivet shape and the gasket 120 were used instead of the electrode terminal 20 having the plate shape and the gasket 30. The electrode terminal 110 included aluminum, and had an outer diameter of the large outer diameter portion of 5 mm and an outer diameter of the small outer diameter portion of 2 mm. The gasket 120 included a perfluoroalkoxy alkane (PFA), and had a thickness of 0.3 mm. In this case, the positive electrode lead 50 was welded to the electrode terminal 110 by a resistance welding method.

### [Evaluation of Battery Characteristic]

Evaluation of the secondary batteries for their battery characteristics (a battery capacity characteristic and safety) revealed the results presented in Table 1.

### (Battery Capacity Characteristic)

The secondary battery was charged and discharged to measure a discharge capacity (a battery capacity (mAh)). The battery capacity was an index for evaluating the battery capacity characteristic. Charging and discharging conditions were similar to those for the stabilization of the secondary battery described above.

In this case, the volume energy density (volume E density (Wh/L = Wh/dm³)) influencing the battery capacity was also calculated based on the capacity (L = dm³) of each of the outer package cans 10 and 80 and the capacity (mAh) of the battery device 40.

### (Safety)

Here, two kinds of tests, i.e., a heating test and a continuous-discharge test, were performed to evaluate safety.

In the heating test, first, the secondary battery was charged in an ambient temperature environment. The charging condition was similar to that for the stabilization of the secondary battery described above. Thereafter, the charged secondary battery was placed on a hot plate. In this case, an orientation of the secondary battery was adjusted in such a manner that a lower part of the electrode terminal 20 (an end part, of the secondary battery, on an opposite side to a side on which a component such as the electrode terminal 20 or the battery cover 91 was disposed) came into contact with a surface of the hot plate. Lastly, the secondary battery was heated at a heating temperature of 200° C. using the hot plate, and a state of the secondary battery, i.e., a post-heating state was visually checked. The state of the secondary battery, i.e., the post-heating state, was an index for evaluating the safety (the heating test).

A case where the electrode terminal 20 served as the release valve, and the outer package can 10 thus did not rupture, i.e., the cover part 12 was thus separated from the container part 11, was determined as “A”. A case where the electrode terminal 20 served as the release valve, but the outer package can 10 ruptured (however, the battery device 40 was not ejected from the inside to the outside of the outer package can 10) was determined as “B”. A case where the electrode terminal 20 did not serve as the release valve and the outer package can 10 ruptured (in particular, the battery device 40 was ejected from the inside to the outside of the outer package can 10) was determined as “C”.

Further, in the continuous-discharge test, first, the secondary battery was charged by a procedure similar to that of the case of performing the heating test. Thereafter, a process of continuously discharging the secondary battery in an ambient temperature environment while measuring a temperature of the secondary battery was repeated 30 times. Thus, a state of the secondary battery (a post-continuous-discharge state) that was an index for evaluating the safety (the continuous-discharge test) was visually checked. The discharging condition was similar to that for the stabilization of the secondary battery described above, except that the current at the time of discharging was changed to 5 C. Note that 5 C was a value of a current that caused the battery capacity to be completely discharged in 0.2 hours.

A case where the electrode terminal 20 did not serve as the release valve and the temperature of the secondary battery was lower than or equal to 60° C. was determined as “A”. A case where the electrode terminal 20 did not serve as the release valve and the temperature of the secondary battery was lower than or equal to 120° C. was determined as “B”. A case where the electrode terminal 20 served as the release valve and the temperature of the secondary battery was higher than or equal to 130° C. was determined as “C”.

TABLE 1

| | Outer package can | Electrode terminal | Fixation strength (kgf/cm²) | Welding strength (kgf/cm²) | Aspect ratio | Fixation ratio | Battery capacity (mAh) | Volume E density (Wh/dm³) | Post-heating state | Post-continuous-discharge state |
|---|---|---|---|---|---|---|---|---|---|---|
| Example 1 | Welded can | Plate shape | 60 | 150 | 0.10 | 1.13 | 9295 | 707 | A | B |
| Example 2 | Welded can | Plate shape | 60 | 150 | 0.28 | 1.13 | 3158 | 669 | A | B |
| Example 3 | Welded can | Plate shape | 60 | 150 | 0.40 | 1.13 | 2111 | 642 | A | B |
| Example 4 | Welded can | Plate shape | 60 | 150 | 0.60 | 1.13 | 1311 | 599 | A | B |
| Comparative example 1 | Crimped can | — | — | — | 0.28 | — | 3000 | 635 | A | B |
| Comparative example 2 | Welded can | Rivet shape | — | — | 0.28 | — | 3158 | 669 | C | B |
| Comparative example 3 | Welded can | Plate shape | 60 | 150 | 1.00 | 1.13 | 674 | 512 | A | A |
| Comparative example 4 | Welded can | Plate shape | 60 | 20 | 0.28 | 1.13 | 3158 | 669 | B | B |
| Comparative example 5 | Welded can | Plate shape | 60 | 150 | 0.08 | 1.13 | 11689 | 711 | B | C |

As presented in Table 1, each of the battery capacity characteristic and the safety varied greatly depending on the configuration of the secondary battery.

In a case where the outer package can 80 that was the crimped can was used (Comparative example 1), the post-heating state and the post-continuous-discharge state were each satisfactory; however, the battery capacity decreased due to a decrease in the volume energy density.

Further, in a case where the outer package can 10 that was the welded can was used, but the electrode terminal 110 of the rivet shape was used (Comparative example 2), the battery capacity increased owing to an increase in the volume energy density, and the post-continuous-discharge state was also satisfactory; however, the post-heating state deteriorated.

In addition, in a case where the outer package can 10 that was the welded can and the electrode terminal 20 having the plate shape were used, but the aspect ratio was 1 (Comparative example 3), the post-heating state and the post-continuous-discharge state were each satisfactory; however, the battery capacity greatly decreased due to a great decrease in the volume energy density. As a result, an amount of heat generation upon discharging and an amount of heat generation upon the occurrence of an abnormal condition each fundamentally decreased.

Note that in a case where the outer package can 10 that was the welded can and the electrode terminal 20 having the plate shape were used, and the aspect ratio was less than 1, but the fixation strength was higher than the welding strength (Comparative example 4), the battery capacity increased owing to an increase in the volume energy density, and the post-continuous-discharge state was satisfactory; however, the post-heating state deteriorated.

Further, in a case where the outer package can 10 that was the welded can and the electrode terminal 20 having the plate shape were used, and the fixation strength was lower than the welding strength, but the aspect ratio was less than 0.1 (Comparative example 5), the battery capacity markedly increased owing to a marked increase in the volume energy density; however, the post-heating state and the post-continuous-discharge state each deteriorated.

In contrast, in a case where the outer package can 10 that was the welded can and the electrode terminal 20 having the plate shape were used, the aspect ratio was greater than or equal to 0.1 and less than 1, and the fixation strength was lower than the welding strength (Examples 1 to 4), the battery capacity increased owing to an increase in the volume energy density while securing a satisfactory post-heating state and a satisfactory post-continuous-discharge state.

In other words, the following was revealed based on comparison between Example 2 and Comparative examples 1, 2, 4, and 5 whose respective aspect ratios were the same, i.e., 0.28. In a case where the outer package can 10 that was the welded can and the electrode terminal 20 having the plate shape were used, where the aspect ratio was greater than or equal to 0.1 and less than 1, and where the fixation strength was lower than the welding strength (Example 2), the post-heating state and the post-continuous-discharge state were each satisfactory, and in addition, the battery capacity (the volume energy density) increased, unlike the cases where not all of those conditions were satisfied (Comparative examples 1, 2, 4, and 5).

In particular, when all of the above-described conditions were satisfied, if the aspect ratio was less than or equal to 0.60 (Examples 1 to 4), a sufficient battery capacity (a sufficient volume energy density) was obtained while a satisfactory post-heating state and a satisfactory post-continuous-discharge state were obtained.

### Examples 5 to 8

As presented in Table 2, secondary batteries were fabricated by a similar procedure except that the fixation ratio was changed, following which the secondary batteries were each evaluated for their safety. In this case, the fixation ratio was changed by varying the inner diameter of the through hole 12K while keeping the outer diameter (15.85 mm) of the electrode terminal 20 constant. Further, for evaluating the safety, the heating test was performed, and a high temperature storage test was performed instead of the continuous-discharge test.

In the high temperature storage test, the secondary battery was charged by a procedure similar to that in the case of performing the heating test, following which the charged secondary battery was stored inside a thermostatic chamber for a storing time of 1 hour. In this case, while increasing a temperature inside the thermostatic chamber and measuring a temperature of the secondary battery, a state of the secondary battery was visually checked. Thus, a release temperature of the secondary battery, i.e., a minimum temperature (°C) at which the electrode terminal 20 served as the release valve was examined. The temperature of the secondary battery, i.e., the minimum temperature (°C) at which the electrode terminal 20 served as the release valve, was an index for evaluating the safety (the heating test).

TABLE 2

| | Outer package can | Electrode terminal | Fixation strength (kgf/cm²) | Welding strength (kgf/cm²) | Aspect ratio | Fixation ratio | Post-heating state | Release temperature (°C) |
|---|---|---|---|---|---|---|---|---|
| Example 5 | Welded can | Plate shape | 20 | 150 | 0.28 | 1.06 | A | 120 |
| Example 2 | Welded can | Plate shape | 60 | 150 | 0.28 | 1.13 | A | 130 |
| Example 6 | Welded can | Plate shape | 90 | 150 | 0.28 | 1.22 | A | 150 |
| Example 7 | Welded can | Plate shape | 140 | 150 | 0.28 | 3.37 | A | 150 |
| Example 8 | Welded can | Plate shape | 150 | 150 | 0.28 | 3.52 | A | 160 |

As presented in Table 2, a satisfactory post-heating state was obtained even if the fixation ratio was changed. In this case, if the fixation ratio was within the range from 1.13 to 3.37 both inclusive (Examples 2, 6, and 7) in particular, the release temperature was within an appropriate range, i.e., from 130° C. to 150° C. both inclusive.

More specifically, if the release temperature was lower than 130° C., the electrode terminal 20 could unintentionally serve as the release valve depending on an increased amount of the internal pressure (an amount of generated gas), for example, during discharging of the secondary battery and during storage of the secondary battery in a high-temperature environment. Further, if the release temperature was higher than 150° C., the outer package can 10 could unintentionally rupture prior to the electrode terminal 20 serving as the release valve at a time of a rapid increase in the internal pressure. Accordingly, if the release temperature was within the appropriate range, the balance between the sealing property and the releasing property regarding the outer package can 10 and the cover part 12 was made appropriate.

Based upon the results presented in Tables 1 and 2, the battery capacity characteristic (the battery capacity and the volume energy density) improved while securing the safety (the post-heating state and the post-continuous-discharge state) if: the battery device 40 was contained inside the outer package can 10 whose aspect ratio (outer diameter D/height H) was greater than or equal to 0.1 and less than 1; in the outer package can 10, the cover part 12 having the through hole 12K was welded to the container part 11; the electrode terminal 20 was fixed to the cover part 12 via the gasket 30; and the fixation strength of the electrode terminal 20 to the cover part 12 was lower than the welding strength of the cover part 12 to the container part 11. Therefore, a superior battery capacity characteristic and superior safety were achieved.

Although the present technology has been described above with reference to one or more embodiments including Examples, the configuration of the present technology is not limited thereto, and is therefore modifiable in a variety of suitable ways.

Although the description has been given of the case where the electrode reactant is lithium, the electrode reactant is not particularly limited in kind. For example, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

It should be appreciated that various changes and modifications to the embodiments described herein will be apparent to those skilled in the art. Such changes and modifications can be made without diminishing its intended advantages. It is therefore intended that such changes and modifications be covered by the appended claims.

1. A battery comprising:
an outer package member having an outer diameter and a height;
a battery device contained inside the outer package member;
a sealing member having an insulating property; and
a terminal member supported by the outer package member via the sealing member, wherein
a ratio of the outer diameter to the height is greater than or equal to 0.1 and less than 1, the outer package member includes
a container member that has an opening, and contains the battery device in an inside of the container member, and
a cover member that is connected to the container member, closes the opening, and has a through hole,
the terminal member is fixed to the cover member via the sealing member, and covers the through hole, and
a fixation strength of the terminal member to the cover member is lower than a connecting strength of the cover member to the container member.

2. The battery according to claim 1, wherein the ratio is greater than or equal to 0.1 and less than or equal to 0.6.

3. The battery according to claim 1, wherein a ratio of an outer diameter of the terminal member to an inner diameter of the through hole is greater than or equal to 1.13 and less than or equal to 3.37.

4. The battery according to claim 1, wherein the terminal member is disposed on an outer side of the cover member.

5. The battery according to claim 1, wherein the sealing member includes polypropylene having a melting point of higher than or equal to 130° C. and lower than or equal to 250° C.

6. The battery according to claim 1, wherein
the battery device includes a positive electrode and a negative electrode that are opposed to each other and are wound, and has a winding center space at a center around which the positive electrode and the negative electrode are wound, and
the through hole is positioned to overlap at least a portion of the winding center space.

7. The battery according to claim 6, wherein an inner diameter of the through hole is larger than an inner diameter of the winding center space.

8. The battery according to claim 1, further comprising
a wiring member that couples the battery device and the terminal member to each other, wherein
the wiring member is folded once or more between the battery device and the terminal member.

9. The battery according to claim 1, wherein
the cover member has a recessed part,
in the recessed part, the cover member bends to protrude in part toward the inside of the container member, and
the terminal member is disposed inside the recessed part.

10. The battery according to claim 1, wherein
the battery device includes a positive electrode and a negative electrode,
the positive electrode is electrically coupled to the terminal member, and
the negative electrode is electrically coupled to the outer package member.

11.
The battery according to claim 1, wherein
the battery device includes a positive electrode and a negative electrode,
the negative electrode is electrically coupled to the terminal member, and
the positive electrode is electrically coupled to the outer package member.

12. The battery according to claim 1, wherein the battery comprises a battery of a cylindrical type.

13. The battery according to claim 1, wherein the battery comprises a lithium-ion secondary battery.
